(19) United States
(12) Patent Application Publication
(10) Pub. No.: US 2026/0314522 A1
(43) Pub. Date: Oct. 15, 2026

(54) CONTROL SYSTEM FOR AN AGRICULTURAL TILLAGE IMPLEMENT

(71) Applicant: CNH Industrial America LLC, New Holland, PA (US)

(72) Inventors: Thomas Eugene Eagan, Peoria, IL (US); William Edward Allen, Peoria, IL (US); Antonio James McClelland, Normal, IL (US); Dylan Jacob Zupec, Granville, IL (US); Derek Sicheneder, Morton, IL (US)

(21) Appl. No.: 19/179,610

(22) Filed: Apr. 15, 2025

(51) Int. Cl. A01B 79/00; A01B 33/16

(52) U.S. Cl. CPC A01B 79/005; A01B 33/16

(57) ABSTRACT

A control system for an agricultural tillage implement includes a seedbed quality sensor configured to output a seedbed quality signal. The control system also includes a controller having a processor and a memory, in which the controller is communicatively coupled to the seedbed quality sensor. The controller is configured to receive the seedbed quality signal from the seedbed quality sensor, determine a seedbed quality based on the seedbed quality signal, determine a target ground speed of the agricultural tillage implement based on the seedbed quality, and output a control signal indicative of the target ground speed.

### BACKGROUND

The present disclosure relates generally to a control system for an agricultural tillage implement.

Certain agricultural implements include ground engaging tools configured to interact with soil. For example, certain tillage implements may include sweep assemblies configured to break up the soil for subsequent planting or seeding operations. Each sweep assembly includes a sweep configured to engage the soil and a shank coupled to the sweep. The shank is pivotally coupled to a frame of the tillage implement, and a biasing element urges the shank to drive the sweep into engagement with the soil. During operation of the tillage implement, one or more sweep assemblies may rotate rearwardly, thereby reducing the penetration depth of the sweep(s) within the soil. As a result, the seedbed established by the tillage implement may be uneven throughout the field, thereby reducing the yield of subsequently planted crops.

### BRIEF DESCRIPTION

In certain embodiments, a control system for an agricultural tillage implement includes a seedbed quality sensor configured to output a seedbed quality signal. The control system also includes a controller having a processor and a memory, in which the controller is communicatively coupled to the seedbed quality sensor. The controller is configured to receive the seedbed quality signal from the seedbed quality sensor, determine a seedbed quality based on the seedbed quality signal, determine a target ground speed of the agricultural tillage implement based on the seedbed quality, and output a control signal indicative of the target ground speed.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIG. 1 is a top view of an embodiment of an agricultural tillage implement having multiple sweep assemblies;

FIG. 2 is a side view of an embodiment of a sweep assembly that may be employed within the agricultural tillage implement of FIG. 1;

FIG. 3 is a block diagram of an embodiment of a control system that may be employed within the agricultural tillage implement of FIG. 1;

FIG. 4 is a diagram of an embodiment of a screen that may be presented on a display of a user interface; and

FIG. 5 is a flow diagram of an embodiment of a method for controlling a ground speed of an agricultural tillage implement.

### DETAILED DESCRIPTION

One or more specific embodiments of the present disclosure will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers’ specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters and/or environmental conditions are not exclusive of other parameters/conditions of the disclosed embodiments.

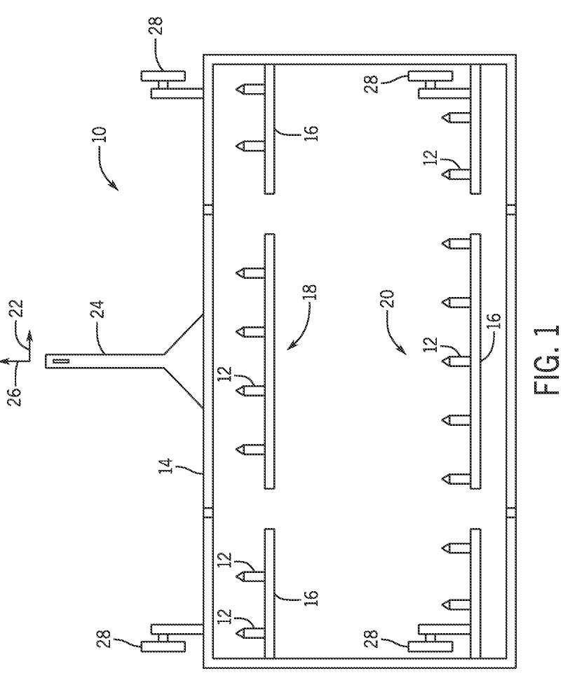

FIG. 1 is a top view of an embodiment of an agricultural tillage implement 10 having multiple sweep assemblies 12. In the illustrated embodiment, the agricultural tillage implement 10 includes a frame 14 having multiple toolbars 16. Each toolbar 16 is configured to support one or more sweep assemblies 12. In the illustrated embodiment, the toolbars 16 are arranged in a front row 18 and a rear row 20. However, in other embodiments, the toolbars may be arranged in any other suitable configuration (e.g., a configuration having three or more rows, in a staggered configuration, etc.). Furthermore, the sweep assemblies 12 are spaced apart from one another with respect to a lateral axis 22 of the agricultural tillage implement 10, and each sweep assembly 12 includes a sweep configured to engage the soil and to break up the soil for subsequent planting or seeding operations. In addition, each sweep assembly 12 includes a shank coupled to the sweep and pivotally coupled to a toolbar 16. The lateral spacing between the sweep assemblies 12 may be selected to enable the agricultural tillage implement 10 to effectively break up the soil along the lateral extent of the agricultural tillage implement 10 (e.g., the extent of the agricultural tillage implement 10 with respect to the lateral axis 22).

The agricultural tillage implement 10 also includes a hitch assembly 24 coupled to the frame 14. The hitch assembly 24 is configured to coupled to a corresponding hitch assembly of an agricultural work vehicle (e.g., tractor, etc.), thereby enabling the agricultural work vehicle to tow the agricultural tillage implement 10 through a field along a direction of travel 26. Furthermore, the agricultural tillage implement 10 includes wheel assemblies 28 coupled to the frame 14. The wheel assemblies 28 are configured to support the frame 14 during tillage operations and during transport of the agricultural tillage implement 10. In addition, each wheel assembly may include an actuator configured to control a vertical position of wheel(s) of the wheel assembly relative to the frame. Accordingly, the actuators of the wheel assemblies may control a height of the frame above a surface of the soil, thereby controlling the penetration depth of the sweep assemblies into the soil.

A respective biasing element (e.g., spring, pneumatic cylinder, hydraulic cylinder, etc.) is configured to urge each sweep assembly 12 to rotate downwardly, thereby urging the shank to drive the sweep into the soil. In response to contact between the sweep and an obstacle within the soil (e.g., rock, etc.), the shank may pivot to enable the sweep to disengage the soil. Once the sweep assembly passes the obstacle, the biasing element may drive the shank to move the sweep back into engagement with the soil. As the ground speed of the agricultural tillage implement 10 increases, one or more of the sweep assemblies 12 may rotate rearwardly, thereby reducing the penetration depth of the sweep(s) within the soil. As a result, the seedbed established by the agricultural tillage implement 10 may be uneven throughout the field, thereby reducing the yield of subsequently planted crops.

In certain embodiments, the agricultural tillage implement 10 includes a control system configured to determine a target ground speed based on the quality of the seedbed created by the sweep assemblies 12. The control system includes a seedbed quality sensor configured to output a seedbed quality signal (e.g., based on a rotation of the shank of a sweep assembly 12 relative to the frame 14, such as the respective toolbar 16 of the frame 14, of the agricultural tillage implement 10). The control system also includes a controller having a processor and a memory, in which the controller is communicatively coupled to the seedbed quality sensor. The controller is configured to receive the seedbed quality signal from the seedbed quality sensor and to determine a seedbed quality based on the seedbed quality signal. Furthermore, the controller is configured to determine a target ground speed of the agricultural tillage implement based on the seedbed quality. In addition, the controller is configured to output a control signal indicative of the target ground speed. For example, in certain embodiments, the control signal may be indicative of instructions to control a user interface to present a visual representation of the target ground speed. An operator of the agricultural tillage implement may control the ground speed based on the target ground speed presented by the user interface. Furthermore, in certain embodiments, the control signal may be indicative of instructions to control an agricultural work vehicle controller of the agricultural work vehicle to control the ground speed of the agricultural tillage implement. Controlling the ground speed of the agricultural tillage implement (e.g., manually via operator input or automatically via the controllers) may enable the sweeps of the sweep assemblies 12 to maintain a target penetration depth within the soil during operation of the agricultural tillage implement. As a result, the agricultural tillage implement may produce a substantially even seedbed throughout the field, thereby enhancing the yield of subsequently planted crops.

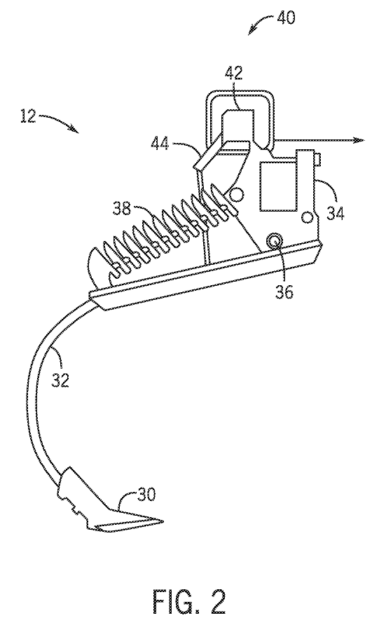

FIG. 2 is a side view of an embodiment of a sweep assembly 12 that may be employed within the agricultural tillage implement of FIG. 1. In the illustrated embodiment, the sweep assembly 12 includes a sweep 30 and a shank 32, in which the sweep 30 is rigidly coupled to the shank 32. In certain embodiments, the sweep 30 is removably coupled to the shank 32, thereby enabling the sweep 30 to be removed and replaced (e.g., due to wear). For example, the sweep 30 may be coupled to the shank 32 by a fastener connection, a press-fit connection, other suitable type(s) of connection(s), or a combination thereof. Furthermore, the shank 32 is pivotally coupled to the toolbar of the agricultural tillage implement frame, thereby enabling the sweep assembly 12 to pivot relative to the agricultural tillage implement frame. In the illustrated embodiment, a mount 34 is rigidly coupled to the toolbar, and the shank 32 is pivotally coupled to the mount 34 via a pivot joint 36, thereby pivotally coupling the shank 32 to the toolbar of the agricultural tillage implement frame. While the shank 32 is pivotally coupled to the toolbar by the mount 34 and the pivot joint 36 in the illustrated embodiment, in other embodiments, the shank may be pivotally coupled to the toolbar via another suitable type of pivoting connection. Furthermore, while the shank 32 is pivotally coupled to the toolbar of the agricultural tillage implement frame in the illustrated embodiment, in other embodiments, the shank may be pivotally coupled to another suitable component of the agricultural tillage implement frame.

A biasing element 38 is configured to urge the sweep assembly 12 to rotate downwardly, thereby urging the shank 32 to drive the sweep 30 into the soil. In the illustrated embodiment, the biasing element 38 includes a single spring. However, in other embodiments, the biasing element may include multiple springs. Furthermore, in certain embodiments, the biasing element may include other suitable biasing device(s) (e.g., alone or in combination with the spring(s)), such as hydraulic cylinder(s), pneumatic cylinder(s), other suitable type(s) of biasing device(s), or a combination thereof. In the illustrated embodiment, the biasing element 38 is pivotally coupled to the shank 32 and to the mount 34. However, in other embodiments, the biasing element may be coupled to other suitable element(s). As previously discussed, in response to contact between the sweep 30 and an obstacle within the soil (e.g., rock, etc.), the shank 32 may pivot to enable the sweep 30 to disengage the soil. Once the sweep assembly 12 passes the obstacle, the biasing element 38 may drive the shank 32 to move the sweep 30 back into engagement with the soil. Furthermore, as the speed of the agricultural tillage implement increases, the sweep assembly 12 may rotate rearwardly, thereby reducing the penetration depth of the sweep 30 within the soil. As a result, the seedbed established by the agricultural tillage implement may be uneven throughout the field, thereby reducing the yield of subsequently planted crops.

As discussed in detail below, the agricultural tillage implement includes a control system 40 having one or more seedbed quality sensors 42. In certain embodiments, each seedbed quality sensor 42 is configured to output a respective seedbed quality signal based on a rotation of the shank 32 of the respective sweep assembly 12 relative to the frame (e.g., the respective toolbar of the frame) of the agricultural tillage implement. Each seedbed quality signal is indicative of a seedbed quality at the location of the respective sweep assembly 12. In the illustrated embodiment, the seedbed quality sensor 42 includes a rotation monitoring sensor (e.g., rotary potentiometer, rotary Hall effect sensor, etc.) having a body and a shaft rotatably coupled to the body. The body of the seedbed quality sensor 42 is rigidly coupled to the mount 34, and the shaft of the seedbed quality sensor 42 is coupled to the shank 32 of the sweep assembly 12 via a linkage 44. The linkage 44 drives the shaft to rotate in response to rotation of the shank 32 about the pivot joint 36, thereby enabling the seedbed quality sensor 42 to monitor the rotation of the shank 32. While the body of the seedbed quality sensor 42 is rigidly coupled to the mount 34 in the illustrated embodiment, in other embodiments, the body may be coupled to another suitable component, such as the respective toolbar of the frame. Furthermore, while the shaft of the seedbed quality sensor 42 is coupled to the shank 32 via the linkage 44 in the illustrated embodiment, in other embodiments, the shaft may be directly coupled to the shank 32. For example, the shaft of the seedbed quality sensor may form part of the pivot joint between the shank and the mount. In addition, while the seedbed quality sensor 42 includes a rotation monitoring sensor in the illustrated embodiment, in certain embodiments, the seedbed quality sensor may include a linear monitoring sensor (e.g., linear potentiometer, linear variable differential transformer (LVDT), etc.) coupled to the shank. Furthermore, the seedbed quality sensor may include a non-contact sensor (e.g., ultrasonic sensor, infrared sensor, camera, RADAR sensor, etc.) configured to monitor the rotation of the shank relative to the frame (e.g., the toolbar of the frame) or the vertical position of the sweep relative to the frame (e.g., the toolbar of the frame). In embodiments in which the seedbed quality sensor includes a linear monitoring sensor or a vertical position sensor, the signal output by the sensor is based on the rotation of the shank because the linear displacement/vertical position change is caused by the rotation of the shank.

In certain embodiments, the control system 40 may include a single seedbed quality sensor 42 configured to monitor the rotation of the shank 32 of one sweep assembly 12. However, in other embodiments, the control system 40 may include multiple seedbed quality sensors 42 configured to monitor the rotation of the shanks 32 of multiple sweep assemblies 12. For example, in certain embodiments, the agricultural tillage implement may be divided into multiple lateral sections (e.g., left section, center section, right section, etc.), and a seedbed quality sensor may be configured to monitor the rotation of the shank of one sweep assembly in each section. Furthermore, in certain embodiments, the rotation of the shank of each sweep assembly of the agricultural tillage implement may be monitored by a respective seedbed quality sensor.

Furthermore, in certain embodiments, the seedbed quality sensor may include a sweep penetration depth monitoring sensor configured to monitor the penetration depth of the sweep below the surface of the field. A higher seedbed quality may result from a more consistent penetration depth of the sweep, and a lower seedbed quality may result from a less consistent penetration depth of the sweep. Accordingly, the seedbed quality may be determined based on variations in the penetration depth of the sweep. The sweep penetration depth monitoring sensor may include contact sensor(s) (e.g., an array of soil contact sensors arranged vertically along the sweep assembly) and/or non-contact sensor(s) (e.g., millimeter wave sensor, ground-penetrating RADAR sensor, etc.). In certain embodiments, the control system may include a single seedbed quality sensor configured to monitor the sweep penetration depth of one sweep assembly. However, in other embodiments, the control system may include multiple seedbed quality sensors configured to monitor the sweep penetration depths of multiple sweep assemblies. For example, in certain embodiments, the agricultural tillage implement may be divided into multiple lateral sections (e.g., left section, center section, right section, etc.), and a seedbed quality sensor may be configured to monitor the sweep penetration depth of one sweep assembly in each section. Furthermore, in certain embodiments, the sweep penetration depth of each sweep assembly of the agricultural tillage implement may be monitored by a respective seedbed quality sensor.

Furthermore, in certain embodiments, the seedbed quality sensor may include a soil monitoring sensor configured to monitor a depth of the seedbed relative to the surface of the field (e.g., behind a respective sweep assembly). A more consistent seedbed depth may be indicative of a higher seedbed quality, and a less consistent seedbed depth may be indicative of a lower seedbed quality. Accordingly, the seedbed quality may be determined based on variations in the seedbed depth. The soil monitoring sensor may include contact sensor(s) (e.g., a soil penetrator configured to monitor soil density, etc.) and/or non-contact sensor(s) (e.g., millimeter wave sensor, ground penetrating RADAR sensor, etc.). In certain embodiments, the control system may include a single seedbed quality sensor configured to monitor the seedbed depth at one position along the width of the agricultural tillage implement. However, in other embodiments, the control system may include multiple seedbed quality sensors configured to monitor the seedbed depth at multiple positions along the width of the agricultural tillage implement. For example, in certain embodiments, the agricultural tillage implement may be divided into multiple lateral sections (e.g., left section, center section, right section, etc.), and a seedbed quality sensor may be configured to monitor the seedbed depth at each section.

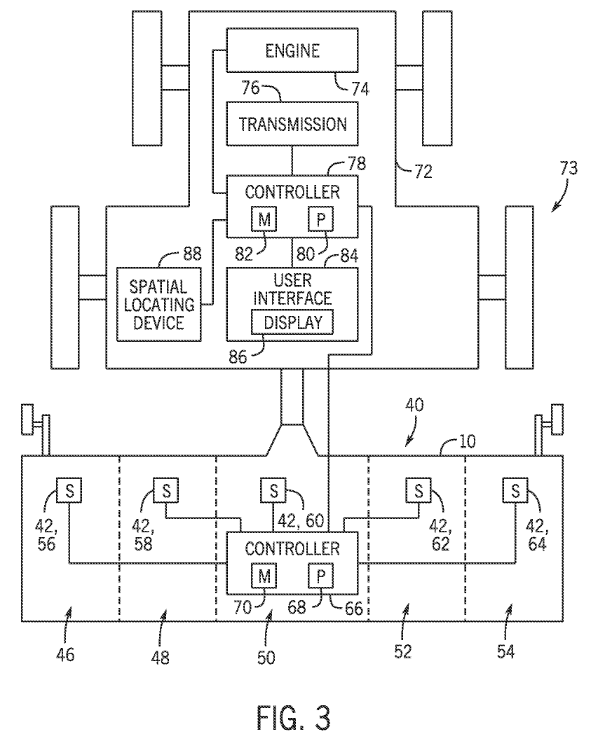

FIG. 3 is a block diagram of an embodiment of a control system 40 that may be employed within the agricultural tillage implement 10 of FIG. 1. In the illustrated embodiment, the control system 40 includes five seedbed quality sensors 42. As previously discussed, each seedbed quality sensor 42 is configured to output a respective seedbed quality signal (e.g., based on a rotation of the shank of a respective sweep assembly relative to the agricultural tillage implement frame, such as the respective toolbar of the agricultural tillage implement frame). In the illustrated embodiment, each seedbed quality sensor 42 is configured to monitor the rotation of the shank of a respective sweep assembly in a respective section of the agricultural tillage implement 10. The agricultural tillage implement 10 is divided into an outer left section 46, an inner left section 48, a center section 50, an inner right section 52, and an outer right section 54. A first seedbed quality sensor 56 is configured to monitor the rotation of the shank of a respective sweep assembly within the outer left section 46, a second seedbed quality sensor 58 is configured to monitor the rotation of the shank of a respective sweep assembly within the inner left section 48, a third seedbed quality sensor 60 is configured to monitor the rotation of the shank of a respective sweep assembly within the center section 50, a fourth seedbed quality sensor 62 is configured to monitor the rotation of the shank of a respective sweep assembly within the inner right section 52, and a fifth seedbed quality sensor 64 is configured to monitor the rotation of the shank of a respective sweep assembly within the outer right section 54.

While the control system 40 includes one seedbed quality sensor 42 for each section of the agricultural tillage implement 10 in the illustrated embodiment, in other embodiments, at least one section may include multiple seedbed quality sensors. For example, in certain embodiments, the rotation of the shank of each sweep assembly of the agricultural tillage implement may be monitored by a respective seedbed quality sensor. Furthermore, while the agricultural tillage implement 10 includes five sections in the illustrated embodiment, in other embodiments, the agricultural tillage implement may include more or fewer sections (e.g., 1, 2, 3, 4, 6, 7, 8, or more), and each section may include one or more seedbed quality sensors. In addition, in certain embodiments, the control system may include a single seedbed quality sensor configured to monitor the rotation of the shank of one sweep assembly. Furthermore, in certain embodiments, the seedbed quality sensor(s) may be configured to monitor the penetration depth(s) of respective sweep(s), or the seedbed quality sensor(s) may be configured to monitor the depth(s) of the seedbed.

In the illustrated embodiment, the control system 40 includes a controller 66 (e.g., agricultural tillage implement controller) communicatively coupled to the seedbed quality sensor(s) 42. In certain embodiments, the controller 66 is an electronic controller having electrical circuitry configured to receive the respective seedbed quality signal from each seedbed quality sensor 42. In the illustrated embodiment, the controller 66 includes a processor 68, such as a microprocessor, and a memory device 70. The controller 66 may also include one or more storage devices and/or other suitable component(s). The processor 68 may be used to execute software, such as software for receiving the respective seedbed quality signal from each seedbed quality sensor 42, and so forth. Moreover, the processor 68 may include multiple microprocessors, one or more “general-purpose” microprocessors, one or more special-purpose microprocessors, and/or one or more application specific integrated circuits (ASICs), or some combination thereof. For example, the processor 68 may include one or more reduced instruction set (RISC) processors.

The memory device 70 may include a volatile memory, such as random access memory (RAM), and/or a nonvolatile memory, such as read-only memory (ROM). The memory device 70 may store a variety of information and may be used for various purposes. For example, the memory device 70 may store processor-executable instructions (e.g., firmware or software) for the processor 68 to execute, such as instructions for receiving the respective seedbed quality signal from each seedbed quality sensor 42, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for receiving the respective seedbed quality signal from each seedbed quality sensor 42, etc.), and any other suitable data.

In embodiments in which the control system 40 includes a single seedbed quality sensor 42, the controller 66 is configured to receive the seedbed quality signal from the seedbed quality sensor 42. The controller 66 is also configured to determine a seedbed quality based on the seedbed quality signal. For example, the seedbed quality signal may be indicative of an angle of rotation of the shank of the sweep assembly about the pivot joint relative to the agricultural tillage implement frame (e.g., the toolbar of the agricultural tillage implement frame), which is indicative of the seedbed quality. The controller 66 may determine a vertical position of the sweep relative to the agricultural tillage implement frame based on the angle of rotation of the shank (e.g., based on the geometry of the shank, the geometry of the sweep, etc.). In addition, the controller 66 may store a relationship (e.g., lookup table, empirical equation, cubic spline, curve fit, linear relationship, etc.) between the vertical position of the sweep and the seedbed quality. The controller 66 may determine the seedbed quality based on the vertical position/seedbed quality relationship and the vertical position of the sweep. Furthermore, in certain embodiments, the controller 66 may store a relationship (e.g., lookup table, empirical equation, cubic spline, curve fit, linear relationship, etc.) between the angle of rotation of the shank and the seedbed quality. In such embodiments, the controller 66 may determine the seedbed quality based on the angle of rotation of the shank and the angle of rotation/seedbed quality relationship. Furthermore, in embodiments in which the seedbed quality sensor is configured to monitor the linear displacement of the shank, the vertical position of the sweep relative to the frame, the penetration depth of the sweep, or the depth of the seedbed, the controller 66 may store a suitable relationship between the monitored parameter and the seedbed quality, and the controller may determine the seedbed quality based on the monitored parameter and the relationship.

With regard to embodiments having multiple seedbed quality sensors 42, the controller may receive each respective seedbed quality signal and determine a respective seedbed quality based on each receive seedbed quality signal. For example, in the illustrated embodiment, the controller 66 may receive a first seedbed quality signal from the first seedbed quality sensor 56, a second seedbed quality signal from the second seedbed quality sensor 58, a third seedbed quality signal from the third seedbed quality sensor 60, a fourth seedbed quality signal from the fourth seedbed quality sensor 62, and a fifth seedbed quality signal from the fifth seedbed quality sensor 64. The controller 66 may then determine a first seedbed quality based on the first seedbed quality signal, a second seedbed quality based on the second seedbed quality signal, a third seedbed quality based on the third seedbed quality signal, a fourth seedbed quality based on the fourth seedbed quality signal, and a fifth seedbed quality based on the fifth seedbed quality signal. Each seedbed quality may be determined based on the techniques disclosed above with regard to the single seedbed quality signal. In certain embodiments, the controller 66 sets the seedbed quality to the lowest seedbed quality. For example, the controller 66 may set the seedbed quality to the lowest of the first seedbed quality, the second seedbed quality, the third seedbed quality, the fourth seedbed quality, or the fifth seedbed quality. However, in other embodiments, the controller may set the seedbed quality to the highest seedbed quality, the average seedbed quality, the median seedbed quality, or another suitable value based on a statistical analysis of the seedbed qualities. Furthermore, in certain embodiments, the controller 66 may store the seedbed qualities and the locations associated with the seedbed qualities, and the controller 66 may create a seedbed quality map as the agricultural tillage implement 10 traverses the field.

The controller 66 is configured to determine a target ground speed of the agricultural tillage implement 10 based on the determined seedbed quality. For example, the controller 66 may set an initial target speed (e.g., input by the operator, determined based on soil type and/or soil condition(s), etc.). The controller 66 may compare the seedbed quality to a target seedbed quality. In response to determining the seedbed quality is below the target seedbed quality, the target ground speed may be reduced. In addition, in response to determining the seedbed quality is above the target seedbed quality, the target ground speed may be increased. In certain embodiments, the change in target speed is based on the difference between the seedbed quality and the target seedbed quality and a relationship (e.g., lookup table, empirical equation, cubic spline, curve fit, linear relationship, etc.) between ground speed and seedbed quality, which may be stored within the controller 66. Furthermore, the controller 66 is configured to output a control signal indicative of the target ground speed. In certain embodiments, the control signal is indicative of instructions to control a user interface to present a visual representation of the target speed. Furthermore, in certain embodiments, the control signal is indicative of instructions to control an agricultural work vehicle controller to control the ground speed of the agricultural tillage implement.

By way of example, in response to determining the seedbed quality is below the target seedbed quality, the controller may reduce the target ground speed and output the control signal indicative of the lower target ground speed. As a result, the ground speed of the agricultural tillage implement may be reduced (e.g., manually via operator input or automatically via the controllers). Reducing the ground speed reduces the load on the sweep assemblies, thereby enabling the biasing elements to drive the sweeps further into the soil (e.g., to a fully engaged position). Accordingly, the agricultural tillage implement may produce a substantially even seedbed throughout the field, thereby enhancing the yield of subsequently planted crops. Furthermore, in response to determining the seedbed quality is above the target seedbed quality, the controller may increase the target ground speed and output the control signal indicative of the higher target ground speed. As a result, the ground speed of the agricultural tillage implement may be increased (e.g., manually via operator input or automatically via the controllers). Increasing the ground speed reduces the duration of the tillage operation, thereby increasing efficiency.

In the illustrated embodiment, the agricultural tillage implement 10 is towed through the field by an agricultural work vehicle 72. However, in other embodiments, the agricultural tillage implement may be supported by the agricultural work vehicle (e.g., via a three-point hitch), or the agricultural tillage implement may be integral with the agricultural work vehicle (e.g., forming a self-propelled vehicle having one or more sweep assemblies coupled to a frame of the self-propelled vehicle). The agricultural tillage implement 10 and the agricultural work vehicle 72 collectively form an agricultural system 73. In the illustrated embodiment, the agricultural work vehicle 72 includes an engine 74 and a transmission 76 configured to drive wheels and/or tracks of the agricultural work vehicle 72. However, in certain embodiments, the transmission may be omitted, and/or the agricultural work vehicle may include one or more electric motors (e.g., alone or in combination with the engine) configured to drive the wheel and/or tracks. Furthermore, the agricultural work vehicle 72 includes an agricultural work vehicle controller 78 configured to control the ground speed of the agricultural work vehicle 72, thereby controlling the ground speed of the agricultural tillage implement 10. In the illustrated embodiment, the agricultural work vehicle controller 78 is communicatively coupled to the engine 74 and the transmission 76, and the agricultural work vehicle controller 78 is configured to control the engine 74 and/or the transmission 76 to control the ground speed of the agricultural work vehicle 72. In embodiments in which the agricultural work vehicle includes electric motor(s), the agricultural work vehicle controller may be communicatively coupled to the electric motor(s) and configured to control the electric motor(s) to control the ground speed of the agricultural work vehicle.

In certain embodiments, the agricultural work vehicle controller 78 is an electronic controller having electrical circuitry configured to control the ground speed of the agricultural work vehicle 72. In the illustrated embodiment, the agricultural work vehicle controller 78 includes a processor 80, such as a microprocessor, and a memory device 82. The agricultural work vehicle controller 78 may also include one or more storage devices and/or other suitable component(s). The processor 80 may be used to execute software, such as software for controlling the ground speed of the agricultural work vehicle 72, and so forth. Moreover, the processor 80 may include multiple microprocessors, one or more “general-purpose” microprocessors, one or more special-purpose microprocessors, and/or one or more application specific integrated circuits (ASICs), or some combination thereof. For example, the processor 80 may include one or more reduced instruction set (RISC) processors.

The memory device 82 may include a volatile memory, such as random access memory (RAM), and/or a nonvolatile memory, such as read-only memory (ROM). The memory device 82 may store a variety of information and may be used for various purposes. For example, the memory device 82 may store processor-executable instructions (e.g., firmware or software) for the processor 80 to execute, such as instructions for controlling the ground speed of the agricultural work vehicle 72, and so forth. The storage device(s) (e.g., nonvolatile storage) may include ROM, flash memory, a hard drive, or any other suitable optical, magnetic, or solid-state storage medium, or a combination thereof. The storage device(s) may store data, instructions (e.g., software or firmware for controlling the ground speed of the agricultural work vehicle 72, etc.), and any other suitable data.

In the illustrated embodiment, the agricultural system 73 includes a user interface 84 communicatively coupled to the agricultural work vehicle controller 78. The user interface 84 is configured to receive input from an operator and to provide information to the operator. The user interface 84 may include any suitable input device(s) for receiving input, such as a keyboard, a mouse, button(s), switch(es), knob(s), other suitable input device(s), or a combination thereof. In addition, the user interface 84 may include any suitable output device(s) for presenting information to the operator, such as speaker(s), indicator light(s), other suitable output device(s), or a combination thereof. In the illustrated embodiment, the user interface 84 includes a display 86 configured to present visual information to the operator. In certain embodiments, the display 86 may include a touchscreen interface configured to receive input from the operator.

In the illustrated embodiment, the user interface 84 is disposed within or on the agricultural work vehicle 72. For example, the user interface 84 may be disposed within a cab of the agricultural work vehicle 72, thereby enabling the operator to interact with the user interface 84 during operation of the agricultural system 73. While the user interface 84 is disposed within or on the agricultural work vehicle 72 in the illustrated embodiment, in certain embodiments, the user interface may be disposed on the agricultural tillage implement. Furthermore, in certain embodiments, the user interface may be remote from the agricultural work vehicle and the agricultural tillage implement, and the user interface may be communicatively coupled to the agricultural work vehicle controller via a wireless connection. For example, the user interface may be part of a remote control system, such as a handheld device, a desktop computer, a laptop computer, a tablet, etc. While the user interface 84 is communicatively coupled to the agricultural work vehicle controller 78 in the illustrated embodiment, in certain embodiments, the user interface may be communicatively coupled to the agricultural tillage implement controller (e.g., alone or in combination with the agricultural work vehicle controller).

In the illustrated embodiment, the agricultural system 73 includes a spatial locating device 88 communicatively coupled to the agricultural work vehicle controller 78. The spatial locating device 88 may include any suitable device(s) configured to output a signal indicative of the ground speed of the agricultural work vehicle 72 and the agricultural tillage implement 10 within the field, such as a global positioning system (GPS) receiver, an inertial measurement unit (IMU), other suitable device(s), or a combination thereof. In certain embodiments, the agricultural work vehicle controller 78 is configured to determine the ground speed of the agricultural work vehicle 72 and the agricultural tillage implement 10 based on feedback from the spatial locating device 88. Furthermore, in certain embodiments, the agricultural work vehicle controller 78 may determine the ground speed of the agricultural work vehicle 72 and the agricultural tillage implement 10 based on feedback from other suitable sensor(s) (e.g., alone or in combination with the spatial locating device 88), such as wheel speed sensor(s), transmission speed sensor(s), engine speed sensor(s), other suitable type(s) of sensor(s), or a combination thereof. While the spatial locating device 88 is mounted on the agricultural work vehicle 72 in the illustrated embodiment, in other embodiments, the spatial locating device may be mounted on the agricultural tillage implement. Furthermore, in certain embodiments, the spatial locating device 88 may be omitted.

As previously discussed, the agricultural tillage implement controller 66 is configured to determine a target ground speed of the agricultural tillage implement 10, which corresponds to a target ground speed of the agricultural work vehicle 72, based on the seedbed quality. In addition, the agricultural tillage implement controller 66 is configured to output a control signal indicative of the target ground speed. In certain embodiments, the control signal is indicative of instructions to control the user interface 84 to present a visual representation of the target ground speed. For example, the agricultural tillage implement controller 66 may output the control signal to the agricultural work vehicle controller 78, and the agricultural work vehicle controller 78 may control the user interface 84 (e.g., by outputting a respective control signal) to present the visual indication of the target ground speed. An operator of the agricultural system 73 may control the ground speed (e.g., via a control input to the user interface 84, via speed control(s) within the cab of the agricultural work vehicle 72, etc.) based on the target ground speed presented by the user interface 84.

In certain embodiments, the agricultural tillage implement controller 66 is configured to determine an adjustment to the ground speed of the agricultural work vehicle 72 and the agricultural tillage implement 10 based on the target ground speed and the ground speed (e.g., as determined based on feedback from the spatial locating device 88). In such embodiments, the control signal may be indicative of instructions to control the user interface 84 to present a visual representation of the adjustment to the ground speed, which is indicative of the target ground speed because the adjustment is based on the target ground speed. For example, the agricultural tillage implement controller 66 may output the control signal to the agricultural work vehicle controller 78, and the agricultural work vehicle controller 78 may control the user interface 84 (e.g., by outputting a respective control signal) to present the visual indication of the adjustment to the ground speed. The operator of the agricultural system 73 may control the ground speed (e.g., via a control input to the user interface 84, via speed control(s) within the cab of the agricultural work vehicle 72, etc.) based on the ground speed adjustment presented by the user interface. In certain embodiments, the agricultural tillage implement controller 66 may receive a signal indicative of the ground speed from the agricultural work vehicle controller 78, thereby enabling the agricultural tillage implement controller to determine the adjustment to the ground speed. Furthermore, in certain embodiments, the agricultural tillage implement controller 66 may output the control signal indicative of the target ground speed to the agricultural work vehicle controller 78, as disclosed above, and the agricultural work vehicle controller 78 may determine the adjustment to the ground speed based on the target ground speed and the ground speed. In such embodiments, the agricultural work vehicle controller 78 may control the user interface 84 (e.g., by outputting a respective control signal) to present the visual indication of the adjustment to the ground speed.

In certain embodiments, the agricultural tillage implement controller 66 and/or the agricultural work vehicle controller 78 may control the user interface 84 to present additional information to the operator. For example, the agricultural tillage implement controller 66 may control the user interface 84 to present a visual representation of the seedbed quality. In certain embodiments, the agricultural tillage implement controller 66 may control the user interface 84 to present a visual representation of the seedbed quality used to determine the target ground speed and/or the respective seedbed qualities determined based on feedback from the seedbed quality sensors (e.g., in embodiments having multiple seedbed quality sensors). Furthermore, in certain embodiments, the agricultural work vehicle controller 78 may control the user interface 84 to present a visual representation of the ground speed (e.g., as determined based on feedback from the spatial locating device 88).

Furthermore, in certain embodiments, the control signal is indicative of instructions to control the agricultural work vehicle controller 78 to control the ground speed of the agricultural work vehicle 72 and the agricultural tillage implement 10. Accordingly, the agricultural tillage implement controller 66 controls the agricultural work vehicle controller 78 to control the ground speed of the agricultural work vehicle 72 and the agricultural tillage implement 10 based on the target ground speed. For example, the agricultural tillage implement controller 66 may control the agricultural work vehicle controller 78 to control the ground speed such that the ground speed is within a threshold range of the target ground speed (e.g., such that the ground speed substantially matches the target ground speed). In certain embodiments, the threshold range may be 0.01 MPH to 0.5 MPH, 0.1 MPH to 0.4 MPH, or 0.2 MPH to 0.3 MPH. As previously discussed, the agricultural work vehicle controller 78 controls the engine 74, the transmission 76, the electric motor(s), or a combination thereof, to control the ground speed of the agricultural work vehicle 72 and the agricultural tillage implement 10. Controlling the ground speed of the agricultural tillage implement may enable the sweeps of the sweep assemblies to maintain a target penetration depth within the soil during operation of the agricultural system. As a result, the agricultural tillage implement may produce a substantially even seedbed throughout the field, thereby enhancing the yield of subsequently planted crops. In embodiments in which the agricultural tillage implement controller 66 controls the agricultural work vehicle controller 78 to control the ground speed, the operator may override the automatic speed control by providing a manual input to an agricultural work vehicle speed control (e.g., pedal, hand controller, etc.).

In certain embodiments, the agricultural tillage implement controller 66 is configured to compare the seedbed quality to a threshold seedbed quality range, and the agricultural tillage implement controller 66 is configured to output the control signal (e.g., control the user interface 84 and/or control the agricultural work vehicle controller 78 to control the ground speed) in response to (e.g., only in response to) determining the seedbed quality is outside of the threshold seedbed quality range. In certain embodiments, the threshold seedbed quality range includes a minimum threshold seedbed quality and a maximum threshold seedbed quality. In such embodiments, the seedbed quality is outside of the threshold seedbed quality range if the seedbed quality is above the maximum threshold seedbed quality or below the minimum threshold seedbed quality. Furthermore, in certain embodiments, the threshold seedbed quality range may only include a minimum threshold seedbed quality (e.g., the threshold seedbed quality range extends from the minimum threshold seedbed quality to a maximum seedbed quality). In such embodiments, the seedbed quality is outside of the threshold seedbed quality range if the seedbed quality is below the minimum threshold seedbed quality. In certain embodiments, the threshold seedbed quality range (e.g., the minimum threshold seedbed quality, the maximum threshold seedbed quality) may be input into the user interface 84, the user interface 84 may output the input indicative of the threshold seedbed quality range, and the agricultural tillage implement controller 66 may receive the input indicative of the threshold seedbed quality range from the user interface 84.

In certain embodiments, the agricultural tillage implement controller 66 is configured to output the control signal (e.g., control the user interface 84 and/or control the agricultural work vehicle controller 78 to control the ground speed) in response to (e.g., only in response to) determining the target ground speed is greater than or equal to a minimum ground speed, and/or the target ground speed is less than or equal to a maximum ground speed. For example, a ground speed increase above the maximum ground speed (e.g., 8 MPH, 9 MPH, 10 MPH, 11 MPH, 12 MPH, etc.) may reduce the efficiency and/or effectiveness of the tillage operation, and a ground speed reduction below the minimum ground speed (e.g., 3 MPH, 3.5 MPH, 4 MPH, 4.3 MPH, 4.5 MPH, 4.7 MPH, 5 MPH, 5.5 MPH, etc.) may not significantly affect the seedbed quality. In certain embodiments, the minimum ground speed and/or the maximum ground speed may be input into the user interface 84, the user interface 84 may output the input indicative of the minimum ground speed and/or the maximum ground speed, and the agricultural tillage implement controller 66 may receive the input indicative of the minimum ground speed and/or the maximum ground speed from the user interface 84. In certain embodiments, the agricultural tillage implement controller 66 may output the control signal in response to determining the target ground speed is greater than or equal to the minimum ground speed. Furthermore, in certain embodiments, the agricultural tillage implement controller 66 may output the control signal in response to determining the target ground speed is less than or equal to the maximum ground speed. In addition, in certain embodiments, the agricultural tillage implement controller 66 may output the control signal in response to determining the target ground speed is greater than or equal to the minimum ground speed, and the target ground speed is less than or equal to the maximum ground speed.

In certain embodiments, the agricultural tillage implement controller 66 is configured to output the control signal (e.g., control the user interface 84 and/or control the agricultural work vehicle controller 78 to control the ground speed) in response to (e.g., only in response to) determining the sweep assemblies are in a working position. In certain embodiments, the frame of the agricultural tillage implement may move between a lowered position, in which the sweep assemblies are in the working position, and a raised position, in which the sweep assemblies are in a non-working position. While the sweep assemblies are in the working position, the sweeps of the sweep assemblies are engaged with the soil, and while the sweep assemblies are in the non-working position, the sweeps of the sweep assemblies are disengaged from the soil. In certain embodiments, the agricultural work vehicle controller 66 is configured to transition the frame between the raised and lowered positions by controlling one or more actuators. In such embodiments, the agricultural work vehicle controller 66 may determine whether the sweep assemblies are in the working position based on the state of the actuator(s). Furthermore, in certain embodiments, the control system includes sensor(s) configured to monitor the position of the sweep assemblies (e.g., based on the height of the frame above the surface of the field, based on the position of the actuator(s), based on the vertical position of the sweeps relative to the surface of the field, etc.), and the controller is configured to determine whether the sweep assemblies are in the working position based on feedback from the sensor(s).

In certain embodiments, the agricultural tillage implement controller 66 is configured to output the control signal (e.g., control the user interface 84 and/or control the agricultural work vehicle controller 78 to control the ground speed) in response to (e.g., only in response to) meeting all or a portion of the criteria disclosed above. For example, in certain embodiments, the agricultural tillage implement controller 66 may output the control signal in response to (e.g., only in response to) determining the seedbed quality is outside of the threshold seedbed quality range, the target ground speed is greater than or equal to the minimum ground speed, the target ground speed is less than or equal to the maximum ground speed, and the sweep assemblies are in the working position. Furthermore, in certain embodiments, the agricultural tillage implement controller 66 may output the control signal in response to (e.g., only in response to) one or more of determining the seedbed quality is outside of the threshold seedbed quality range, determining the target ground speed is greater than or equal to the minimum ground speed, determining the target ground speed is less than or equal to the maximum ground speed, or determining the sweep assemblies are in the working position. In addition, in certain embodiments, the agricultural tillage implement controller 66 may output the control signal without satisfying any of the criteria disclosed above.

Furthermore, in certain embodiments, the agricultural tillage implement controller 66 may receive the seedbed quality signal(s) from the seedbed quality sensor(s) in response to determining the ground speed of the agricultural work vehicle and the agricultural tillage implement is stable. For example, the agricultural tillage implement controller 66 may receive the seedbed quality signal(s) in response to (e.g., only in response to) determining variations in the ground speed are less than a threshold value for a threshold duration. Furthermore, in certain embodiments, the agricultural tillage implement controller 66 may filter each seedbed quality signal (e.g., via a low pass filter) during the process of determining each seedbed quality based on the respective seedbed quality signal.

While certain functions are disclosed as being performed by the agricultural tillage implement controller 66 or the agricultural work vehicle controller 78, any of the functions disclosed as being performed by the agricultural tillage implement controller 66 may be performed by the agricultural work vehicle controller 78, and any of the functions disclosed as being performed by the agricultural work vehicle controller 78 may be performed by the agricultural tillage implement controller 66. For example, in certain embodiments, the agricultural work vehicle controller or the agricultural tillage implement controller may be omitted. Furthermore, in certain embodiments, the agricultural tillage implement controller may directly control the user interface and/or the ground speed (e.g., by directly controlling the engine, the transmission, the electric motor(s), or a combination thereof).

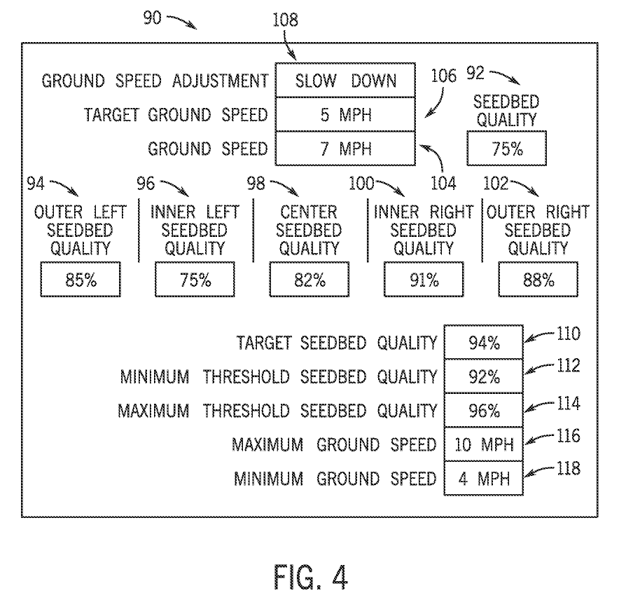

FIG. 4 is a diagram of an embodiment of a screen 90 that may be presented on the display of the user interface. In the illustrated embodiment, the screen 90 includes a seedbed quality field 92, an outer left seedbed quality field 94, an inner left seedbed quality field 96, a center seedbed quality field 98, an inner right seedbed quality field 100, and an outer right seedbed quality field 102. The outer left seedbed quality field 94 presents a visual representation of the seedbed quality at the outer left section of the agricultural tillage implement (e.g., as determined based on feedback from the first seedbed quality sensor). The inner left seedbed quality field 96 presents a visual representation of the seedbed quality at the inner left section of the agricultural tillage implement (e.g., as determined based on feedback from the second seedbed quality sensor). The center seedbed quality field 98 presents a visual representation of the seedbed quality at the center section of the agricultural tillage implement (e.g., as determined based on feedback from the third seedbed quality sensor). The inner right seedbed quality field 100 presents a visual representation of the seedbed quality at the inner right section of the agricultural tillage implement (e.g., as determined based on feedback from the fourth seedbed quality sensor). The outer right seedbed quality field 102 presents a visual representation of the seedbed quality at the outer right section of the agricultural tillage implement (e.g., as determined based on feedback from the fifth seedbed quality sensor). The seedbed quality field 92 presents a visual representation of the seedbed quality used to determine the target ground speed. As previously discussed, the seedbed quality used to determine the target ground speed may be the lowest of the seedbed qualities at the sections of the agricultural tillage implement.

In the illustrated embodiment, the seedbed quality is represented as a percent between 0 percent and 100 percent, in which a higher percentage represents a higher seedbed quality. However, in other embodiments, the seedbed quality may be represented by another suitable value. Furthermore, while the screen 90 includes fields for the seedbed qualities at the sections of the agricultural tillage implement in the illustrated embodiment, in other embodiments, the fields for the seedbed qualities at the sections may be omitted. In addition, while the screen 90 includes the seedbed quality field 92 in the illustrated embodiment, in other embodiments, the seedbed quality field may be omitted.

In the illustrated embodiment, the screen 90 includes a ground speed field 104, a target ground speed field 106, and a ground speed adjustment field 108. The ground speed field 104 presents a visual representation of the ground speed of the agricultural work vehicle and the agricultural tillage implement (e.g., as determined based on feedback from the spatial locating device). Furthermore, the target ground speed field 106 presents a visual representation of the target ground speed determined based on the seedbed quality. In certain embodiments, the operator may control the ground speed based on the target ground speed presented in the target ground speed field 106. Furthermore, in certain embodiments, the agricultural tillage implement controller may control the agricultural work vehicle controller to control the ground speed of the agricultural work vehicle and the agricultural tillage implement. In addition, the ground speed adjustment field 108 presents a visual representation of the ground speed adjustment. As previously discussed, the agricultural tillage implement controller may determine the adjustment to the ground speed based on the target ground speed and the ground speed. In certain embodiments, the operator may control the ground speed based on the adjustment presented in the ground speed adjustment field 108. In the illustrated embodiment, the ground speed adjustment may be selected from one of “speed up”, “maintain speed”, and “slow down”. However, in other embodiments, the ground speed adjustment may include a speed change direction and a speed change magnitude (e.g., small speed increase, large speed increase, small speed decrease, large speed decrease, increase speed by 2 MPH, decrease speed by 1 MPH, etc.).

While the screen 90 includes the ground speed field 104, the target ground speed field 106, and the ground speed adjustment field 108 in the illustrated embodiment, in other embodiments, at least one of the speed fields may be omitted. For example, in certain embodiments (e.g., in embodiments in which the ground speed is manually controlled by the operator), the target ground speed field may be omitted. Furthermore, in certain embodiments (e.g., in embodiments in which the ground speed is automatically controlled by the agricultural tillage implement controller), the ground speed adjustment field may be omitted.

In the illustrated embodiment, the screen 90 includes a target seedbed quality field 110, a minimum threshold seedbed quality field 112, a maximum threshold seedbed quality field 114, a maximum ground speed field 116, and a minimum ground speed field 118. The target seedbed quality field 110 enables the operator to enter a target seedbed quality (e.g., represented as a percentage). As previously discussed, the agricultural tillage implement controller may compare the seedbed quality to the target seedbed quality to determine the target ground speed. Furthermore, the minimum threshold seedbed quality field 112 and the maximum threshold seedbed quality field 114 enable the operator to input the threshold seedbed quality range. As previously discussed, the agricultural tillage implement controller may compare the seedbed quality to the threshold seedbed quality range, which includes the minimum threshold seedbed quality and the maximum threshold seedbed quality, and to output the control signal in response to determining the seedbed quality is outside of the threshold seedbed quality range (e.g., above the maximum threshold seedbed quality, or below the minimum threshold seedbed quality). In certain embodiments, the agricultural tillage implement controller may automatically provide values to the minimum threshold seedbed quality field 112 and the maximum threshold seedbed quality field 114 based on the target seedbed quality. For example, the agricultural tillage implement controller may provide values that are a percentage above or below the target seedbed quality (e.g., 1 percent, 2 percent, 3 percent, 4 percent, etc.). The threshold seedbed quality fields enable the operator to override the automatically determined values.

In addition, the maximum ground speed field 116 and the minimum ground speed field 118 enable the operator to input the maximum ground speed and the minimum ground speed, respectively. In certain embodiments, the agricultural tillage implement controller may not enable the operator to enter a maximum ground speed greater than the maximum rated ground speed of the agricultural tillage implement. As previously discussed, the agricultural tillage implement controller may output the control signal in response to determining the target ground speed is greater than or equal to the minimum ground speed, and/or the target ground speed is less than or equal to the maximum ground speed.

While the screen 90 includes fields for each input value in the illustrated embodiment, in other embodiments, the screen may include other suitable input control(s) to receive one or more of the input values, such as slider(s), button(s), etc. Furthermore, in certain embodiments, any or all of the input controls (e.g., fields) may be omitted. For example, in certain embodiments (e.g., in embodiments in which the target ground speed is not compared to the maximum ground speed), the maximum ground speed field may be omitted. Furthermore, in certain embodiments (e.g., in embodiments in which the target ground speed is not compared to the minimum ground speed), the minimum ground speed field may be omitted. In addition, in certain embodiments (e.g., in embodiments in which the seedbed quality is not compared to the threshold seedbed quality range), the minimum threshold seedbed quality field and the maximum threshold seedbed quality field may be omitted. In certain embodiments, the screen may include other suitable input control(s) (e.g., field(s), slider(s), button(s), etc.) configured to enable the operator to input other input value(s). For example, in certain embodiments, the screen may include an aggressiveness input control that enables the operator to input an aggressiveness. In such embodiments, the agricultural tillage implement controller may control the frequency of outputting the control signal based on the aggressiveness. Furthermore, in certain embodiments (e.g., in embodiments in which the agricultural tillage implement controller controls the agricultural work vehicle controller to control the ground speed), the screen may include an input control (e.g., button(s), slider, field, etc.) for a ground speed override. The ground speed override enables the operator to manually control the ground speed (e.g., if the operator determines that a ground speed different than the target ground speed is desired).

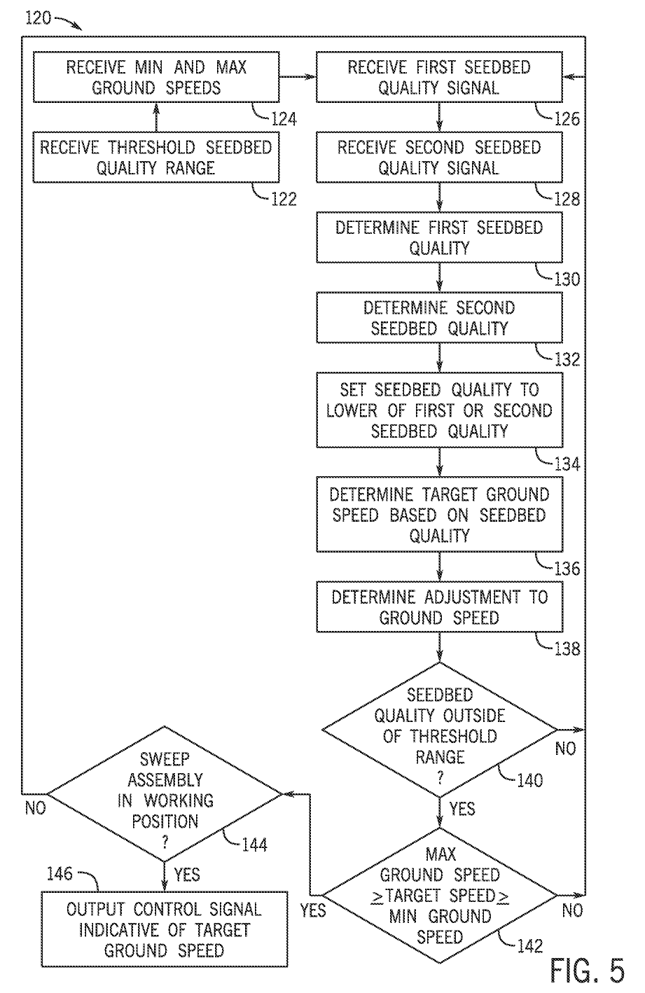

FIG. 5 is a flow diagram of an embodiment of a method 120 for controlling a ground speed of an agricultural tillage implement. The method 120 may be performed by the agricultural tillage implement controller disclosed above with reference to FIG. 3, the agricultural work vehicle controller disclosed above with reference to FIG. 3, by one or more other suitable controllers, or a combination thereof. Furthermore, the steps of the method 120 may be performed in the order disclosed below or in any other suitable order. In addition, in certain embodiments, one or more steps of the method 120 may be omitted, and/or the method may include one or more additional steps.

In certain embodiments, the method 120 includes receiving an input indicative of a threshold seedbed quality range, as represented by block 122. As previously discussed, the threshold seedbed quality range may include a maximum threshold seedbed quality and a minimum threshold seedbed quality. Furthermore, as previously discussed, the input indicative of the threshold seedbed quality range may be received from the user interface. In addition, in certain embodiments, the method 120 includes receiving an input indicative of a minimum ground speed and/or a maximum ground speed, as represented by block 124. As previously discussed, the input indicative of the minimum ground speed and/or the maximum ground speed may be received from the user interface.

The method 120 also includes receiving, from a first seedbed quality sensor, a first seedbed quality signal, as represented by block 126. As previously discussed, the first seedbed quality sensor is configured to output the first seedbed quality signal (e.g., based on the rotation of the shank of a first sweep assembly relative to the frame of the agricultural tillage implement). In addition, the method 120 includes receiving, from a second seedbed quality sensor, a second seedbed quality signal, as represented by block 128. As previously discussed, the second seedbed quality sensor is configured to output the second seedbed quality signal (e.g., based on the rotation of the shank of a second sweep assembly relative to the frame of the agricultural tillage implement). Furthermore, the method 120 includes determining the first seedbed quality based on the first seedbed quality signal, as represented by block 130, and determining the second seedbed quality based on the second seedbed quality signal, as represented by block 132. As previously discussed, the controller may use one or more relationships and the respective parameter monitored by each seedbed quality sensor to determine the respective seedbed quality. The method 120 also includes setting the seedbed quality to a lower of the first seedbed quality or the second seedbed quality, as represented by block 134.

While the method 120 includes determining the seedbed quality based on two seedbed qualities in the illustrated embodiment, in other embodiments, the method may include determining the seedbed quality based on more or fewer seedbed qualities. For example, in certain embodiments, the method may include receiving five seedbed quality signals, determining five respective seedbed qualities based on the five seedbed quality signals, and setting the seedbed quality to the lowest of the five respective seedbed qualities. Furthermore, in certain embodiments, the method may include receiving one seedbed quality signal, and determining the seedbed quality based on the seedbed quality signal. In such embodiments, the step of setting the seedbed quality to the lower/lowest of multiple seedbed qualities may be omitted.

In addition, the method 120 includes determining a target ground speed of the agricultural tillage implement based on the seedbed quality, as represented by block 136. As previously discussed, the target ground speed may be determined by comparing the seedbed quality to a target seedbed quality and increasing or decreasing the target speed based on the difference between the seedbed quality and the target seedbed quality, and a ground speed/seedbed quality relationship. In certain embodiments, the method 120 includes determining an adjustment to the ground speed based on the target ground speed and the ground speed, as represented by block 138.

In certain embodiments, the method 120 includes comparing the seedbed quality to a threshold seedbed quality range, as represented by block 140. As previously discussed, in certain embodiments, the threshold seedbed quality range includes a maximum threshold seedbed quality and a minimum threshold seedbed quality, and the seedbed quality is outside of the threshold seedbed quality range if the seedbed quality is above the maximum threshold seedbed quality or below the minimum threshold seedbed quality. The method 120 may return to block 126 in response to determining the seedbed quality is within the threshold seedbed quality range. Furthermore, in certain embodiments, the method 120 includes comparing the target ground speed to the maximum ground speed and the minimum ground speed, as represented by block 142. The method 120 may return to block 126 in response to determining the target ground speed is greater than the maximum ground speed or less than the minimum ground speed. In addition, in certain embodiments, the method 120 includes determining whether the sweep assemblies are in the working position, as represented by block 144. The method 120 may return to block 126 in response to determining the sweep assemblies are not in the working position.

In response to determining the seedbed quality is outside of the threshold seedbed quality range (e.g., above the maximum threshold seedbed quality or below the minimum threshold seedbed quality), the target ground speed is greater than or equal to the minimum ground speed and less then or equal to the maximum ground speed, and the sweep assemblies are in the working position, a control signal indicative of the target ground speed is output, as represented by block 146. In certain embodiments, the control signal is indicative of instructions to control a user interface to present a visual representation of the target speed. Furthermore, in embodiments in which the adjustment to the ground speed is determined, the control signal may be indicative of instructions to control the user interface to present a visual representation of the adjustment to the ground speed. In addition, in certain embodiments, the control signal is indicative of instructions to control an agricultural work vehicle controller to control the ground speed of the agricultural tillage implement.

In certain embodiments, the step of comparing the seedbed quality to the threshold seedbed quality range may be omitted. In such embodiments, the step of receiving the threshold seedbed quality range may be omitted. Furthermore, in certain embodiments, the step of comparing the ground speed to the minimum ground speed and/or the maximum ground speed may be omitted. In such embodiments, the step of receiving the minimum ground speed and/or the maximum ground speed may be omitted. In addition, in certain embodiments, the step of determining whether the sweep assemblies are in the working position may be omitted. In certain embodiments, the step of determining the adjustment to the ground speed may be omitted.

While only certain features have been illustrated and described herein, many modifications and changes will occur to those skilled in the art. It is, therefore, to be understood that the appended claims are intended to cover all such modifications and changes as fall within the true spirit of the disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function]…” or “step for [perform]ing [a function]…”, it is intended that such elements are to be interpreted under 35 U.S.C. 112(f). However, for any claims containing elements designated in any other manner, it is intended that such elements are not to be interpreted under 35 U.S.C. 112(f).

1. A control system for an agricultural tillage implement, comprising:
a seedbed quality sensor configured to output a seedbed quality signal; and
a controller comprising a processor and a memory, wherein the controller is communicatively coupled to the seedbed quality sensor, and the controller is configured to:
receive the seedbed quality signal from the seedbed quality sensor;
determine a seedbed quality based on the seedbed quality signal;
determine a target ground speed of the agricultural tillage implement based on the seedbed quality; and
output a control signal indicative of the target ground speed.

2. The control system of claim 1, wherein the controller is configured to determine an adjustment to a ground speed of the agricultural tillage implement based on the target ground speed and the ground speed, and the control signal is indicative of instructions to control a user interface to present a visual representation of the adjustment to the ground speed.

3. The control system of claim 1, wherein the controller is configured to compare the seedbed quality to a threshold seedbed quality range, and the controller is configured to output the control signal in response to determining the seedbed quality is outside of the threshold seedbed quality range.

4. The control system of claim 3, wherein the controller is configured to receive an input indicative of the threshold seedbed quality range from a user interface.

5. The control system of claim 1, wherein the controller is configured to output the control signal in response to determining the target ground speed of the agricultural tillage implement is greater than or equal to a minimum ground speed, and the target ground speed of the agricultural tillage implement is less than or equal to a maximum ground speed.

6. The control system of claim 1, wherein the seedbed quality sensor is configured to output the seedbed quality signal based on a rotation of a shank of a sweep assembly relative to a frame of the agricultural tillage implement.

7. The control system of claim 1, comprising a second seedbed quality sensor configured to output a second seedbed quality signal, wherein the controller is communicatively coupled to the second seedbed quality sensor, and the controller is configured to:
receive the second seedbed quality signal from the second seedbed quality sensor;
determine a second seedbed quality based on the second seedbed quality signal; and
set the seedbed quality to a lower of the seedbed quality or the second seedbed quality before determining the target ground speed.

8. At least one non-transitory computer readable medium comprising executable instructions that, when executed by a processor, are configured to cause the processor to:
receive, from a seedbed quality sensor, a seedbed quality signal;
determine a seedbed quality based on the seedbed quality signal;
determine a target ground speed of the agricultural tillage implement based on the seedbed quality; and
output a control signal indicative of the target ground speed.

9. The at least one non-transitory computer readable medium of claim 8, wherein the executable instructions, when executed by the processor, are configured to cause the processor to determine an adjustment to a ground speed of the agricultural tillage implement based on the target ground speed and the ground speed, and the control signal is indicative of instructions to control a user interface to present a visual representation of the adjustment to the ground speed.

10. The at least one non-transitory computer readable medium of claim 8, wherein the executable instructions, when executed by the processor, are configured to cause the processor to:
compare the seedbed quality to a threshold seedbed quality range; and
output the control signal in response to determining the seedbed quality is outside of the threshold seedbed quality range.

11. The at least one non-transitory computer readable medium of claim 10, wherein the executable instructions, when executed by the processor, are configured to cause the processor to receive an input indicative of the threshold seedbed quality range from a user interface.

12. The at least one non-transitory computer readable medium of claim 8, wherein the executable instructions, when executed by the processor, are configured to cause the processor to output the control signal in response to determining the target ground speed of the agricultural tillage implement is greater than or equal to a minimum ground speed, and the target ground speed of the agricultural tillage implement is less than or equal to a maximum ground speed.

13. The at least one non-transitory computer readable medium of claim 8, wherein the seedbed quality sensor is configured to output the seedbed quality signal based on a rotation of a shank of a sweep assembly relative to a frame of an agricultural tillage implement.

14. The at least one non-transitory computer readable medium of claim 8, wherein the executable instructions, when executed by the processor, are configured to cause the processor to:
receive, from a second seedbed quality sensor, a second seedbed quality signal;
determine a second seedbed quality based on the second seedbed quality signal; and
set the seedbed quality to a lower of the seedbed quality or the second seedbed quality before determining the target ground speed.

15. An agricultural system, comprising:
an agricultural work vehicle controller comprising a processor and a memory, wherein the agricultural work vehicle controller is configured to control a ground speed of an agricultural work vehicle; and
a control system for an agricultural tillage implement configured to be towed by the agricultural work vehicle, wherein the control system comprises:
a seedbed quality sensor configured to output a seedbed quality signal based on a rotation of a shank of a sweep assembly relative to a frame of the agricultural tillage implement; and
an agricultural tillage implement controller comprising a processor and a memory, wherein the agricultural tillage implement controller is communicatively coupled to the seedbed quality sensor and to the agricultural work vehicle controller, and the agricultural tillage implement controller is configured to:
receive the seedbed quality signal from the seedbed quality sensor;
determine a seedbed quality based on the seedbed quality signal;
determine a target ground speed of the agricultural work vehicle based on the seedbed quality; and
control the agricultural work vehicle controller to control the ground speed of the agricultural work vehicle based on the target ground speed.

16. The agricultural system of claim 15, comprising a user interface communicatively coupled to the agricultural work vehicle controller, and the agricultural tillage implement controller is configured to control the agricultural work vehicle controller to control the user interface to display the target ground speed.

17. The agricultural system of claim 15, wherein the agricultural tillage implement controller is configured to compare the seedbed quality to a threshold seedbed quality range, and the agricultural tillage implement controller is configured to control the agricultural work vehicle controller to control the ground speed in response to determining the seedbed quality is outside of the threshold seedbed quality range.

18. The agricultural system of claim 15, wherein the agricultural tillage implement controller is configured to control the agricultural work vehicle controller to control the ground speed in response to determining the target ground speed is greater than or equal to a minimum ground speed, and the target ground speed is less than or equal to a maximum ground speed.

19. The agricultural system of claim 15, wherein the agricultural tillage implement controller is configured to control the agricultural work vehicle controller to control the ground speed in response to determining the sweep assembly is in a working position.

20. The agricultural system of claim 15, wherein the control system comprises a second seedbed quality sensor configured to output a second seedbed quality signal based on a rotation of a shank of a second sweep assembly relative to the frame of the agricultural tillage implement, the agricultural tillage implement controller is communicatively coupled to the second seedbed quality sensor, and the agricultural tillage implement controller is configured to:
receive the second seedbed quality signal;
determine a second seedbed quality based on the second seedbed quality signal; and
set the seedbed quality to a lower of the seedbed quality or the second seedbed quality before determining the target ground speed.
